(19) United States
(12) Patent Application Publication
(10) Pub. No.: US 2005/0049974 A1
(43) Pub. Date: Mar. 3, 2005

(54) Credit card payment processing system and method

(76) Inventors: Ali Jani, Fairfax, VA (US); Nayan Vadher, Gainesville, VA (US)

Correspondence Address: DLA PIPER RUDNICK GRAY CARY USA, LLP, 2000 UNIVERSITY AVENUE, E. PALO ALTO, CA, 94303-2248, US

(21) Appl. No.: 10/847,769

(22) Filed: May 17, 2004

Related U.S. Application Data
(60) Provisional application No. 60/498,878, filed on Aug. 29, 2003.

(51) Int. Cl. G06F 17/60

(52) U.S. Cl. 705/64

(57) ABSTRACT

Business Software Systems that process credit card transactions interface with another payment processing software or payment gateway to process the transactions. For a Business Software System to directly interface with payment processing software or payment gateway, the Transaction Requests have to be formulated in the format mandated by the payment gateway or payment processing software. The Transaction Request has to be conveyed to the payment gateway using the communication protocol that is stipulated by the payment gateway or Payment Processor. An Intermediary Payment Processor allows a Business Software System to interface with another payment processing software or payment gateway although the format and communication protocol used by the Business Software System is different from the format and protocol required by the payment gateway or Payment Processor. The intermediary processing system is setup to contain definitions for the format used by the Business Software System, the equivalent definitions for the format used by the payment gateway and the communication protocols used by both. The intermediary reads the Transaction Request in the format generated by the Business Software System, translates it into the format required by the payment gateway, receives the response and the transaction result; and translates the response into the format that is understood by the Business Software System.

### PRIORITY CLAIM

This application claims priority under 35 USC 119 to U.S. Provisional Patent Application Ser. No. 60/498,878, filed on Aug. 29, 2003 and entitled “Credit Card Payment Processing System and Method” which is incorporated herein by reference.

### FIELD OF THE INVENTION

The present invention relates generally to a Payment Processor and more particularly to a method and apparatus for enabling the processing of credit card Transaction Requests generated by Business Software Systems by Payment Processors and gateways that use different request formats and communication protocols.

### BACKGROUND OF THE INVENTION

Payment processing systems allow for processing of payments through different payment methods such as credit cards, electronic checks, and debit cards. Payment processing systems also allow for interfacing with other Business Software Systems thus allowing the Business Software System to integrate real time payment processing into their business processes. Payment processing systems are critical for real time processing of payments for purchasing transactions.

An example of the interfacing of a business software application and a payment processing systems is the interface is the interface between the Everest Advanced Edition (Everest) (a Business Software System developed and marketed by iCode, Inc.) and ICVERIFY (a payment processing software from Verisign). Everest allows merchants with ICVERIFY accounts to process customer receipts and refunds through ICVERIFY. Everest generates Transaction Request files in the format stipulated by ICVERIFY. The ICVERIFY payment processing software reads the Transaction Request file and contacts the processing network for further processing of the transaction. ICVERIFY then formulates the response of the processing network in an answer file and Everest reads the answer file and records the response in the form of metadata in its database. Everest also performs further actions such as recording the payment based on whether the Transaction Request was approved or not.

The basic presumption for the operation of this automated interface to work is that Everest generates the Transaction Requests in a form understood and required by ICVERIFY and communicates the Transaction Request in a protocol stipulated by ICVERIFY. For Everest to support additional Payment Processors other than ICVERIFY, Everest would need a separate interface for each Payment Processor as each Payment Processor has its own unique data structures and formats. Thus, it is desirable to provide a payment processing system and method that overcomes the limitations of the present system and it is to this end that the present invention is directed.

### SUMMARY OF THE INVENTION

A payment processing intermediary of the present invention allows users of a business software application, such as Everest, to use Payment Processors that are not supported within Everest. The intermediary would have within it the required mechanism to map existing output formats with Transaction Requests that are generated by Everest to formats required by other processors. It would also have within it the necessary setup requirements to communicate with the Business Software System and the Payment Processor in different protocols. The advantages of using an intermediary are that Business Software System vendors can allow their users to use different Payment Processors supported by the intermediary without making changes to their code base and users can advantageously use the Payment Processors that suit them best without having to change their Business Software System or switch to processing payment transactions manually.

In accordance with the invention, there is provided a method and an apparatus for a Business Software System to communicate with different Payment Processors without having to generate Transaction Request in the specific formats stipulated by each processor or having the necessary mechanisms for directly communicating with the processor. The Intermediary Payment Processor has the required definitions for communication protocols and Transaction Requests from Business Software Systems in the formats understood by different Payment Processors, such as ICVERIFY and PayFlowPro for example. In one example, the Intermediary Payment Processor also has the corresponding formats for the data format supported by PC Charge Payment Server. In one example, the Intermediary Payment Processor monitors the specified ports or folders for Transaction Requests in a format published by ICVERIFY and PayFlowPro; and translates these Transaction Requests to formats published by PC Charge Payment Server. The Intermediary Payment Processor then translates the response from PC Charge Payment Server to the format published by ICVERIFY or PayFlowPro. The Business Software System from which the Transaction Request originated will now be able to decipher the response and carry out further actions based on the type of response. In accordance with the invention, the Intermediary Payment Processor may be used with various different Payment Processors. In accordance with the invention, the intermediate Payment Processor can translate between the formats of the different Payment Processors and can be updated to handle new Payment Processors using, in a preferred embodiment, an extended mark-up language (XML) translator.

The Intermediary Payment Processor provides many advantages since it permits Business Software Systems to support multiple Payment Processors without making changes to their code base. The system also enables the existing users of Business Software Systems to switch to a Payment Processor not supported by their current Business Software System without having to make changes to the data setup in their software or having to resort to a manual system of processing payments. The system also permits the users of multiple Business Software Systems to use a single intermediary and multiple Payment Processors and multiple merchant accounts. The system also allows Websites and on-line shops that are dependent on TCP/IP and other protocols for real time payment processing to conveniently use Payment Processors that are based on an alternate method of connection such as dial-up without having to make changes to their Website or on-line shop.

Thus, in accordance with the invention, a Payment Processor is provided. The Payment Processor stores the required definitions for communication protocols and Transaction Requests from Business Software Systems in the formats understood by any payment processing software and the formats for the data format supported by the payment server so as to monitor the specified ports or folders for Transaction Requests in a format published by the payment processing software. The system has a module to translate these Transaction Requests to formats published by the payment server and to translate the response from the payment server to the format published by the payment processing software so as to enable the Business Software System from which the Transaction Request has originated to decipher the response and carry out further actions based on the type of response.

In accordance with another aspect of the invention, a Payment Processor is provided. The Payment Processor is software comprising a set of instructions to format the transaction data based on the payment processing software, set up the merchant account information for each merchant account with the corresponding payment server, identify the output mode of the transactions requests for this merchant account as a Transaction Request file or through a port, identify the folder in which the Transaction Request file is to be placed or the port to which the Transaction Request is to be sent, specify the maximum number of transactions that the intermediary is allowed to process concurrently, and in each step, updates the database with the setup data. The Payment Processor may further include software instructions to intercede between the Business Software System and the Payment Processor by receiving Transaction Requests and assigning them for further processing by retrieving the information for a particular monitor and processor from its database, begin monitoring based on the monitor type, create a repository of the processor templates objects based on the number of concurrent transactions specified, create Worker Threads based on the configuration settings and create the number of workers available, such that if workers are available end the process, or if workers are not available create Worker Threads and then end the process.

In accordance with yet another aspect of the invention, a Payment Processor is provided that is software comprising a set of instructions. The software formats the transaction data based on the payment processing software, sets up the merchant account information for each merchant account with the corresponding payment server, identifies the output mode of the Transaction Requests for this merchant account as a Transaction Request file or through a port, identifies the folder in which the Transaction Request file is to be placed or the port to which the Transaction Request is to be sent, and specifies the maximum number of transactions that the intermediary is allowed to process concurrently, and in each step, updates the database with the setup data. The software also has a further set of software instructions to process a payment request comprising a means to identify the source of the Transaction Request and the format in which the Transaction Request has been sent, identifying the processor to which the Transaction Request should be directed, assigning the Transaction Request received to the processor object and the Thread, and if free, begin to process the Transaction Request by translating the Transaction Request from its current format to the format in which the processor requires the Transaction Requests to be transmitted and then transmit the Transaction Request after due validation, redirecting the response from the processor to the format recognized by the source of the Transaction Request, or in case the processor object and the Thread are not free, send it to the queue.

In accordance with yet another aspect of the invention, a method for operating an Intermediary Payment Processor is provided. In the method, the definitions for transaction data generated by the Business Software System are specified along with the equivalent definitions to be used for transmitting such information to the Payment Processor. The definitions for the format into which the responses from the Payment Processor need to be converted are specified in order that the information can be read and understood by the Business Software System. Furthermore, the folders or ports that need to be monitored by the intermediary for Transaction Requests are specified from the Business Software System and the merchant account and other information is specified that would be used by the intermediary to connect to the Payment Processor. The method may preserve these definitions in the form of metadata. The method may start the monitoring service whereby the folders or ports would be monitored for Transaction Requests. The method also handles Transaction Requests and conveys the results of the Transaction Requests to the respective folders or ports.

### BRIEF DESCRIPTION OF THE DRAWINGS

These and other aspects of the invention will become apparent from the following description read in conjunction with the accompanying drawings:

FIG. 1 is a system that incorporates the payment processing system in accordance with the invention;

FIG. 2 is a flow diagram showing the interface between a Business Software System such as Everest and a supported Payment Processor such as ICVERIFY;

FIG. 3 is a flow diagram giving an example of how a credit card payment is processed in the absence of a seamless interface with a Payment Processor;

FIG. 4 is a diagram that illustrates the activities of software development required for a Business Software System such as Everest to support another Payment Processor such as PC Charge Payment Server;

FIG. 5 illustrates an example of the setup in the intermediary to interface between a Business Software System that generates Transaction Requests in a format supported by the Business Software System and an unsupported Payment Processor wherein Everest is the Business Software System, ICVERIFY and PayFlowPro are the supported payment processors and PC Charge Payment Server is a Payment Processor not supported by Everest;

FIG. 6 is a diagram showing how the intermediary intercedes between the Business Software System and the Payment Processor by receiving Transaction Requests and assigning them for further processing;

FIG. 7A is a flow diagram that illustrates how the intermediary obviates the necessity for implementing a direct interface in a Business Software System through the steps in FIG. 3 by enabling the processing of Transaction Requests from a Business Software System such as Everest through other processors such as PC Charge Payment Server (a Payment Processor not supported by Everest);

FIG. 7B is a diagram illustrating a computer system implementation of the Credit Card Payment Processing System in accordance with the invention;

FIG. 8 is a prototype of how the intermediary would be configured to interact with PC Charge Payment Server and any other Business Software System;

FIG. 9 is a prototype image of how the intermediary would monitor and display the status of the different Transaction Requests received;

FIG. 10 is an example of a configuration user interface to set-up the monitoring module of the intermediary in accordance with the invention;

FIG. 11 is an example of a configuration user interface to set-up the intermediary for a particular payment processor system; and

FIGS. 12A and 12B illustrate an example of a payment processing Transaction Request and the translated output for PCCharge, respectively.

### DETAILED DESCRIPTION OF A PREFERRED EMBODIMENT

The invention is particularly applicable to a Credit Card Payment Processing System that has been incorporated into the Everest Business Software System developed by iCode, Inc. and it is in this context that the invention will be described. It will be appreciated, however, that the Credit Card Payment Processing System and method in accordance with the invention has greater utility as it may be used with any systems in which it may be desirable to have a Payment Processing System with the features described herein so that it may be used with other payment methods and systems, with various Business Software Systems and with various Payment Processors.

For the purpose of the following description, certain specified terms will be defined.

Business Software System: Any software that is used to process and record transactions related to sales and purchasing, in general, and receipts from customers, in particular.

Everest: A Business Software System developed by iCode, Inc. that is used throughout the description as an example of Business Software Systems into which the Credit Card Payment Processing Systems may be incorporated.

Payment Processor: A processor that facilitates the processing of payments through credit cards, debit cards, electronic checks and other forms. In one example, the Payment Processor sends the Transaction Request for processing a credit card payment, routes it through the financial network, obtains a response from the issuer of the credit card identifying whether adequate funds are available in the card holder's account and displays the response to the person or website (in case of e-commerce) initiating the Transaction Request.

Transaction Request: Any request for processing a payment transaction, such as a credit card transaction for example. The request may be for different types of processing such as an authorization, sale, refund, or a void transaction.

ICVERIFY: An example of a Payment Processor that normally requires request and formulates response in a file format with prescribed definitions.

PayFlowPro: An example of a Payment Processor that uses the TCP/IP protocol.

Intermediary Payment Processor: A Payment Processor that interfaces between Business Software Systems and Payment Processors that use differing data formats and/or connection protocols. The Intermediary Payment Processor helps to bridge the gaps in file formats and connection protocols between Business Software Systems and Payment Processors.

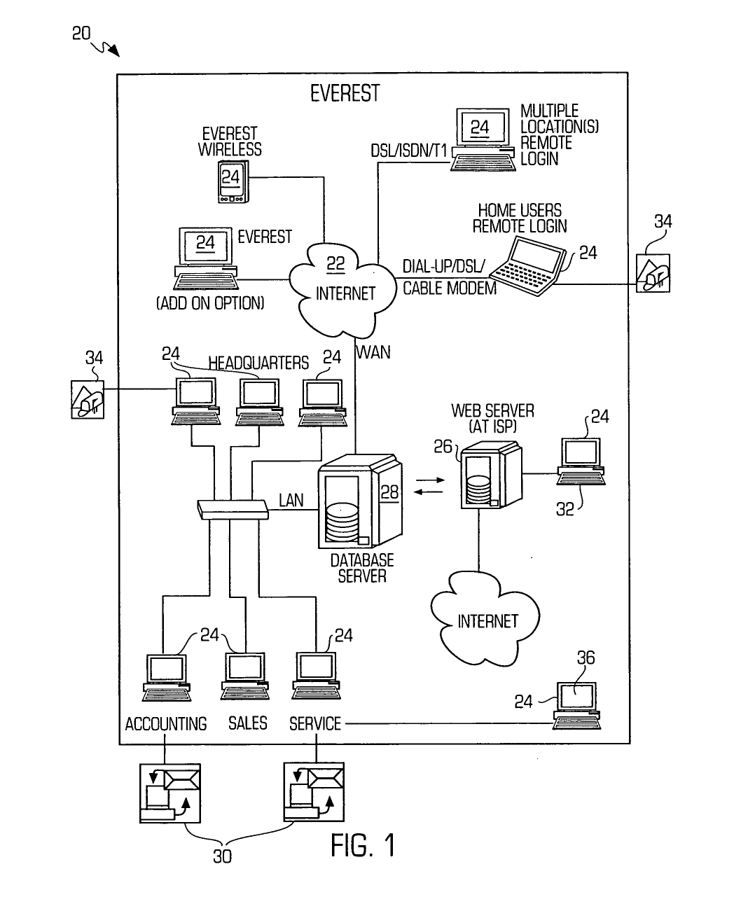

A system that may incorporate the payment processing system in accordance with the invention is described as follows. FIG. 1 is an overall block diagram of a Business Software System 20 that incorporates a payment processing system in accordance with the invention. In the preferred embodiment, the system 20 is the Everest software application that is being executed on a computer network/system as shown. However, the system 20 may also be any other Business Software System and the invention is not limited to the Everest system. The system 20 is connected together by a computer network 22, such as the Internet as shown, the World Wide Web (Web) or any other computer network, wherein a plurality of different computing resources 24 are connected together. Each computing resource 24 is a computer system that is capable of executing computer software code to implement the Business Software System and the payment processing system, such as the laptop, wireless device and desktop systems as shown. Each computing resource has the well known components of a computer system, such as one or more processors, memory, such as SRAM or DRAM or flash memory, a persistent storage device, such as a hard disk drive, optical disk drive or tape drive, and optional input/output devices, such as keyboards, mice, LCDs, CRTs and printers. The system is not limited to any particular type of computing resource, however, as the Business Software System may be implemented using various computer systems. The computing resources of the system 20 are connected together by a wide area network (WAN) and a local area network (LAN) as shown. As shown, the system 20 also may include a Web Server 26 that permits Web access to the system by the computer resources 24. The system 20 may further include a Database Server 28 which is connected to the various computing resources and acts as a data repository for the system and its parts. The elements of the Database Server 28 are well known and not described herein. In a preferred embodiment, a Microsoft SQL server may be used, but the Database Server may also be implemented using an Oracle or Siebel product.

The system may further include a mail management system 30 that is integrated within Microsoft Outlook e-mail client. The mail management system allows employees to be more informed on all email interactions between customers and anyone in an organization and enables a user to access to all such emails stored within Everest. In a preferred embodiment, the mail management system is one or more pieces of software code, executing on a computing resource 24. The system may further include a PageBoost system 32, a search engine solution that integrates with Everest by generating optimized HTML pages ready to be submitted to various search engines for higher page ranking, traffic hits and seamlessly integrates with the Everest. In a preferred embodiment, the PageBoost system is one or more pieces of software code, executing on a computing resource 24, that perform various functions. The system may further include an e-mail client system 34 that sends and receives email directly from Everest. Employees are more informed because they have access to all email sent between customers, vendors and anyone in an organization, wherein the Everest Email client replaces any e-mail client such as Microsoft Outlook and integrates with Everest. In a preferred embodiment, the e-mail client system is one or more pieces of software code, executing on a computing resource 24, that perform various functions. The system may further include a PayBridge system 36 that bridges between different Payment Processors for processing payment transactions, such as credit card transactions, with different Payment Processors and integrates with Everest allowing users to use their own Payment Processors. In a preferred embodiment, the PayBridge system is one or more pieces of software code, executing on a computing resource 24, that perform various functions. The payment processing system (PayBridge) will now be described below in more detail.

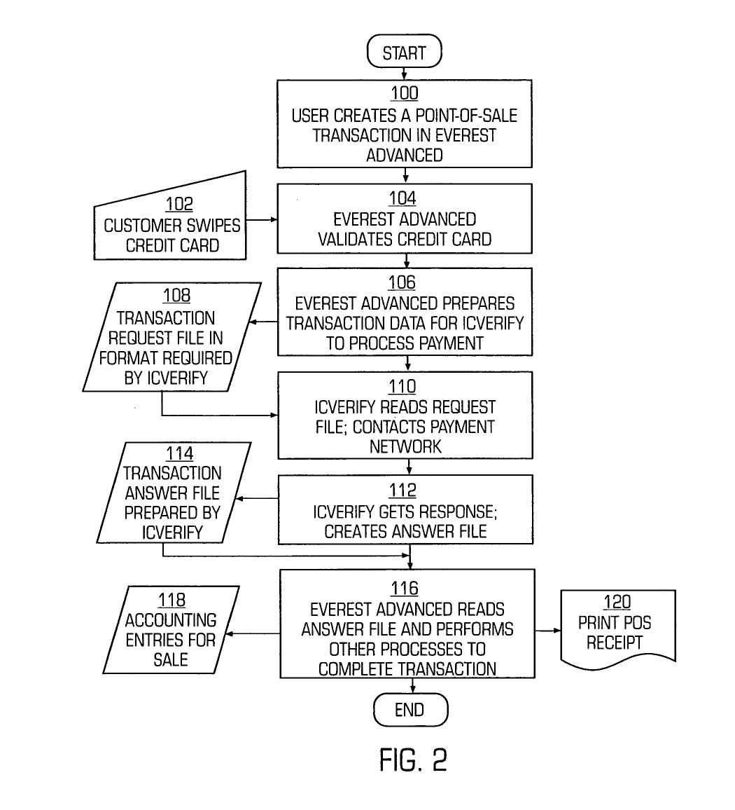

FIG. 2 is a graphical flow diagram that illustrates how a credit card payment is generally processed by a Business Software System with a direct interface to a Payment Processor such as ICVERIFY. FIG. 2 has been depicted here to illustrate how a common connection protocol and a common file format is absolutely essential to enable a Business Software System to seamlessly interface with a Payment Processor. In step 100, a user creates a point-of-sale (POS) transaction in the Business Software System. In steps 102 and 104, the user of the Business Software System swipes a credit card and the Business Software System validates the credit card. In step 106, the Business Software System prepares the transaction data so that ICVERIFY can process the payment. In step 108, the Transaction Request is generated in the exact format as required by ICVERIFY. The ICVERIFY software reads the Transaction Request file and then processes the transaction including contacting the payment network in step 110. On receiving a response, ICVERIFY formats the response in the answer file in steps 112 and 114. In step 116, the Business Software System reads the answer file and performs other processes to complete the transaction wherein the Business Software System includes a mechanism to understand the components of the answer file and decipher the response. In step 118, the accounting entries for the sale are generated by the Business Software System and a POS receipt is printed in step 120. An example of payment processing without seamless integration is described as follows to illustrate the desirability for seamless integration.

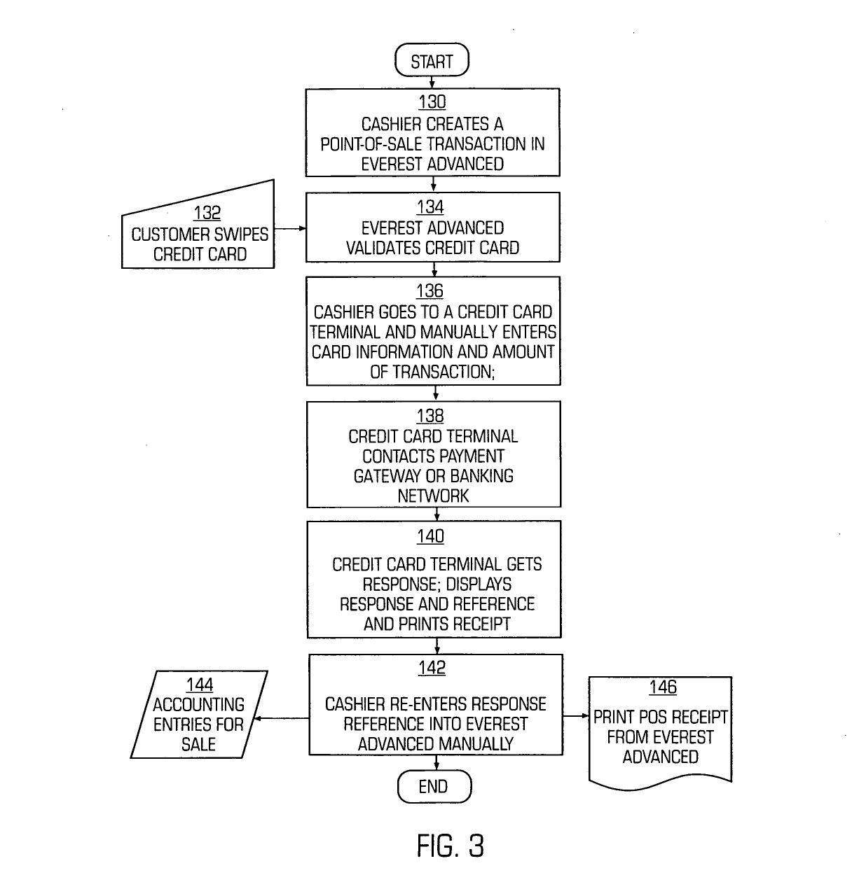

FIG. 3 is a graphical flow diagram that illustrates what a user of a Business Software System would have to do if there is no seamless interface between the Business Software System and the credit card processor. In step 130, the cashier creates a POS transaction in the Business Software System. In steps 132 and 134, the user swipes his or her credit card and the Business Software System validates the credit card. In step 136, the cashier goes to a credit card terminal and manually enters the credit card information and the amount of the transaction. In step 138, the credit card terminal contacts the payment gateway or banking network. In step 140, the credit card terminal receives a response, displays the response reference and prints a receipt. In step 142, the cashier re-enters the response reference manually into the Business Software System and accounting entries are made in step 144 and a POS receipt is printed in step 146 to complete the transaction. This diagram illustrates the fact that the lack of a seamless interface and the requirement for manual intervention lends itself to more labor as well as creates the opportunity for clerical mistakes such as processing for incorrect amounts and entering incorrect data into the Business Software System. If there is no interface, the cashier at a POS terminal would have to duplicate activities such as entering credit card information and the amount to be processed into the credit card terminal and would have to re-enter the result of the Transaction Request into the Business Software System. This results in process inefficiencies. The objective of the depiction in FIG. 3 is to illustrate how an intermediary Credit Card Payment Processing System in accordance with the invention achieves the seamless interface depicted in FIG. 2 even when the conditions necessary for such an interface are absent.

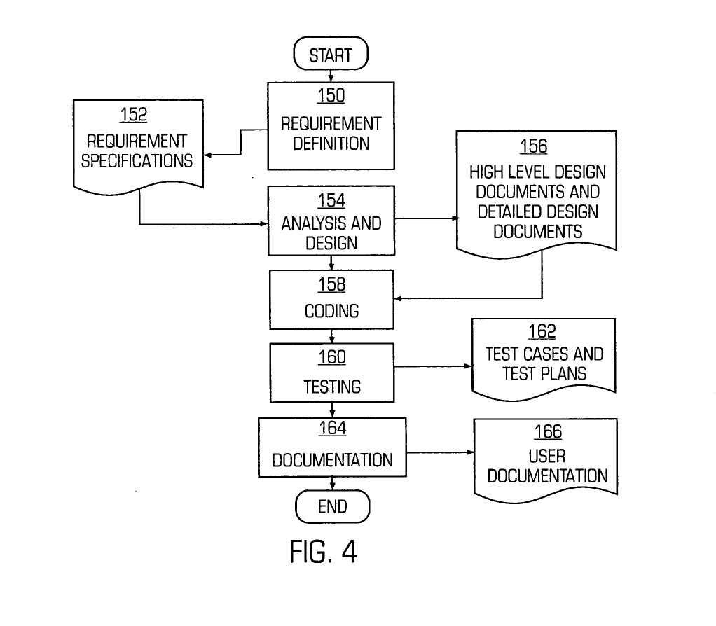

FIG. 4 illustrates the activities in the different phases of a software development life cycle that would be typically required if a direct interface with a new Payment Processor was to be introduced into an existing Business Software System. It will be appreciated that supporting a new Payment Processor entails not only time but also would require ancillary activities such as maintenance for format changes by the Payment Processor, updating the existing users of the Business Software System with the new executable files, and updates to user documentation. In step 150, a requirements definition for a new Payment Processor is received and the requirements specifications are determined in step 152. In step 154, the Business Software System designer must analyze and design the interface to the new Payment Processor and generate high level design documents and detailed design documents in step 156. In step 158, the interface for the new Payment Processor is coded and then tested in step 160. In step 162, test cases and test plans are generated and reviewed. In step 164, once testing is completed, documentation is generated in step 164 including user documentation 166. In accordance with the invention, the intermediate Credit Card Payment Processing System avoids the above steps to implement the direct interface for a new Payment Processor as the present invention is able to integrate new Payment Processors without changing the code base of the Business Software System.

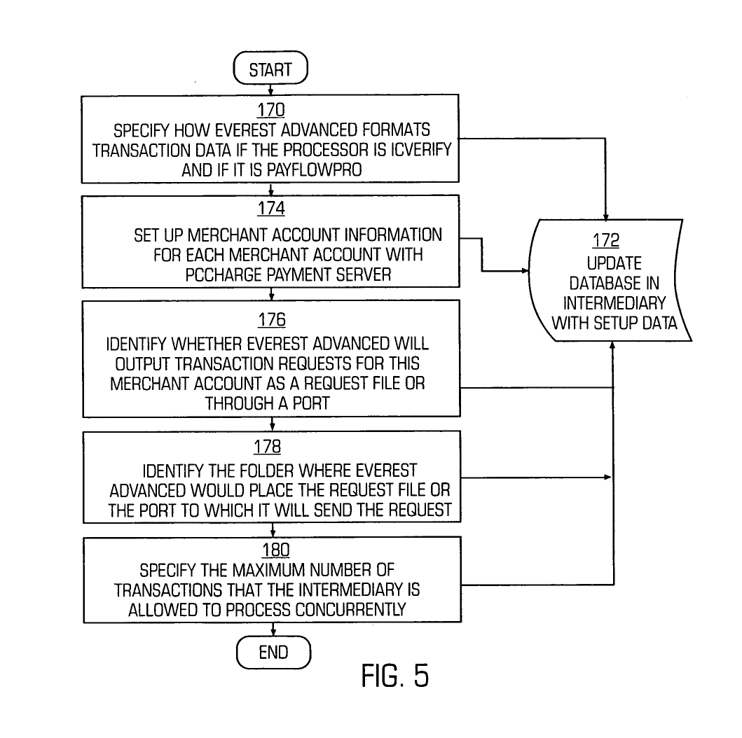

FIG. 5 is a flow diagram that illustrates how the intermediary would be setup to facilitate the use of a new Payment Processor in conjunction with an existing Business Software System. For purposes of illustration, the flow diagram uses the example of the Everest Business Software System which currently supports ICVERIFY and PayFlowPro Payment Processors but does not support PC Charge Payment Server. ICVERIFY uses dial-up connections to transmit and receive information from the payment gateway; and it requires that the Transaction Request from Everest be in the format of a Transaction Request file. PayFlowPro connects to the payment gateway using TCP/IP as the protocol. It transmits information using ports.

If a user of Everest wants to use PC Charge Payment Server, and still needs a seamless interface, the user can use the intermediary Credit Card Payment Processing System in accordance with the invention. FIG. 5 depicts the initial setup in the intermediary wherein the merchant account information to access PC Charge, and the folder or port to which the Transaction Request and response would be routed is shown/configured. In accordance with the invention, each different Payment Processor may require a different set-up and the Credit Card Payment Processing System in accordance with the invention may be used with various different Payment Processors. As can be seen, the intermediary provides the flexibility to support Transaction Requests in different formats and can convert Transaction Requests to the appropriate format required by the intended processor (in this case, PC Charge Payment Server). In step 170, the format of the transaction data for the existing Payment Processors, ICVERIFY and PayFlowPro, is defined and then stored in a database associated with the intermediary system in step 172. In step 174, the merchant account information for each merchant account with the PC Charge Payment Server (the new Payment Processor) is determined and then stored in the database. In step 176, the set-up determines if the Business Software System will generate Transaction Requests for this merchant account as a Transaction Request file or through a port and stores that data into the database. In step 178, the set-up identifies the folder into which the Business Software System would place the Transaction Request file or the port to which it will send the Transaction Request and stores that data into the database. In step 180, the maximum number of transactions that the intermediary is allowed to process concurrently is specified and then stored in the database. The defining of the maximum number of transactions permits the user to control the load on the system. In addition, each Payment Processor may have licensing restrictions on the number of simultaneously-processed transactions so the user can use the maximum number of concurrent transactions to stay within the license requirements. A method for monitoring the Transaction Requests in accordance with the invention is described as follows.

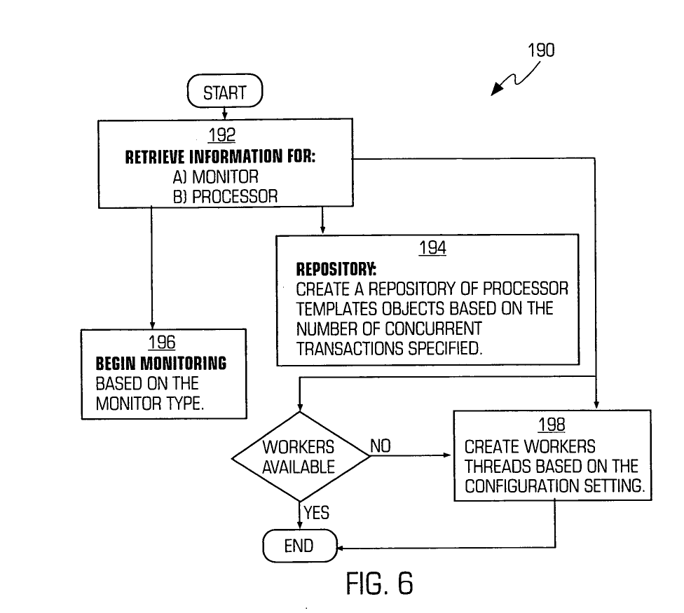

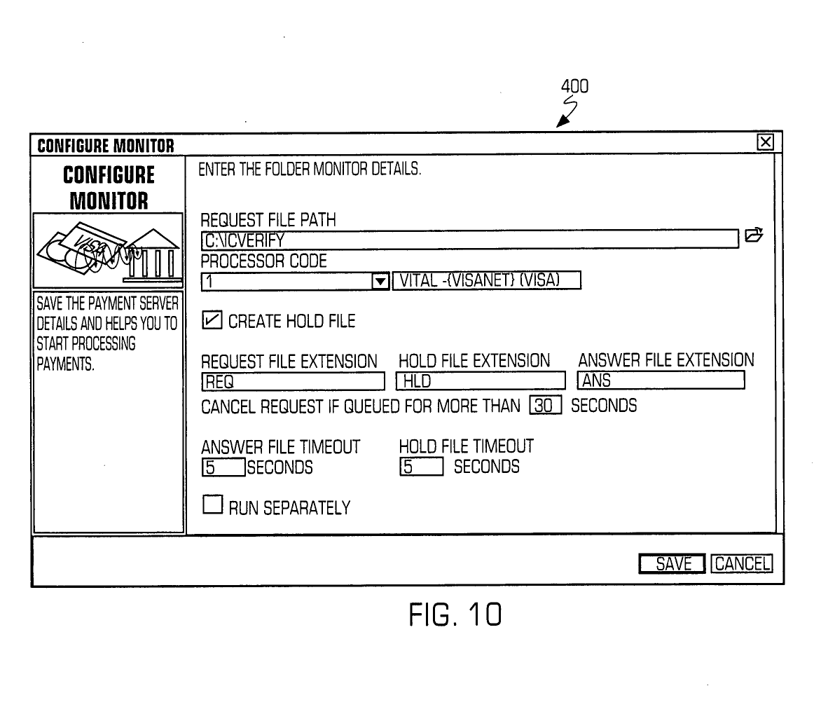

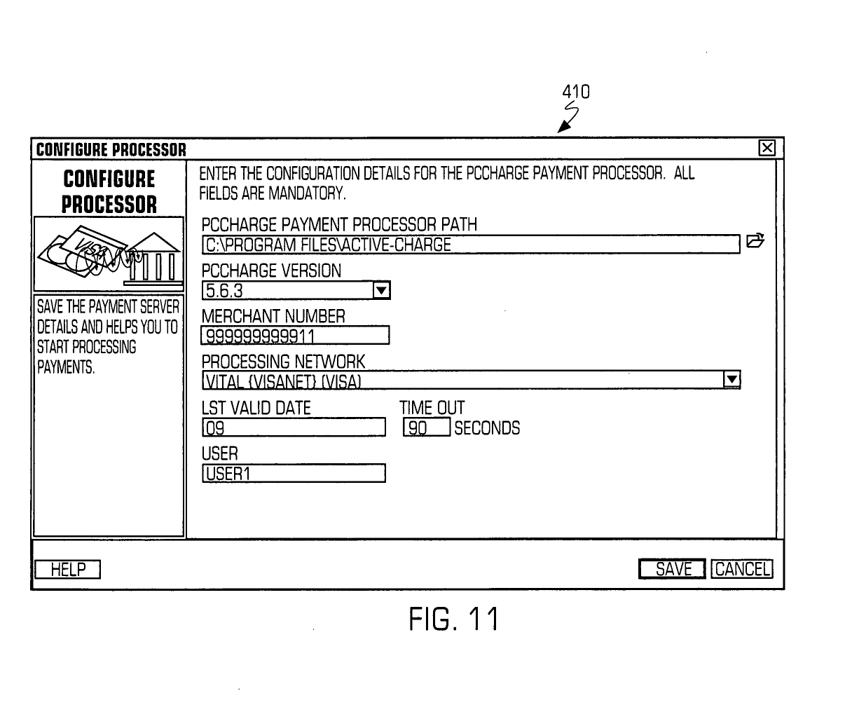

FIG. 6 is a diagram showing the how the intermediary's monitoring service 190 monitors Transaction Requests. When the intermediary's monitoring service is initiated for a processor, it retrieves information for that processor from its database in step 192 wherein each Payment Processor has a profile in the database that contains the relevant information about that Payment Processor such as the format of the data. The configuration set-up user interface for the monitoring server and the Payment Processor will be described in more detail below with reference to FIGS. 10 and 11. It then creates as many instances of the processor object as the number of concurrent transactions allowed for the processor and as specified in the processor settings in step 194 and begins monitoring based on the monitor type in step 196. It also creates as many Threads for processing Transaction Requests as are specified in the general configuration for the intermediary in step 198. A method for processing a payment request in accordance with the invention is described in more detail as follows.

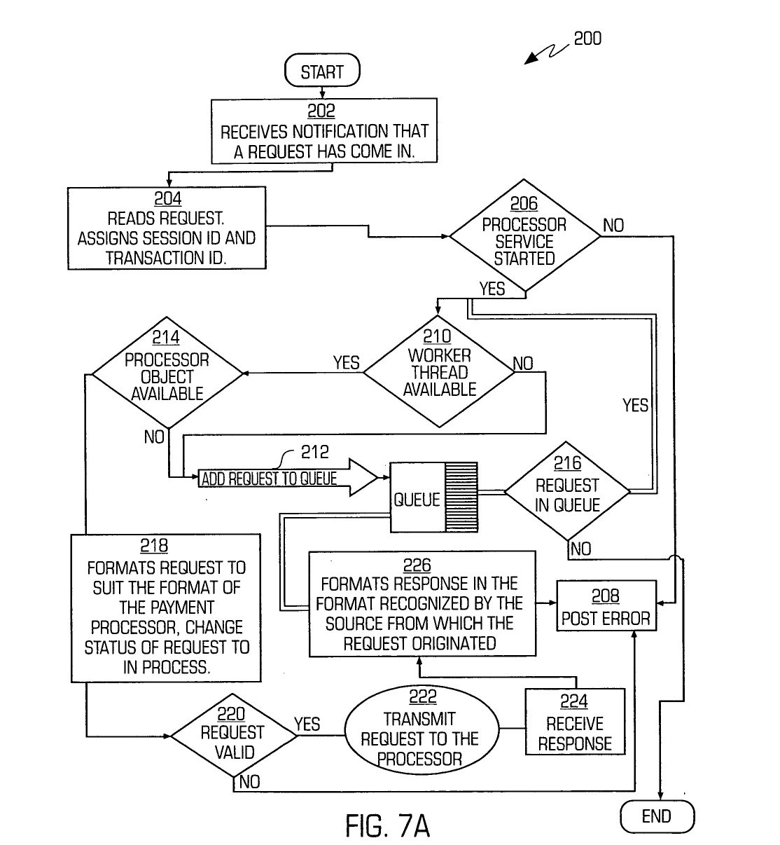

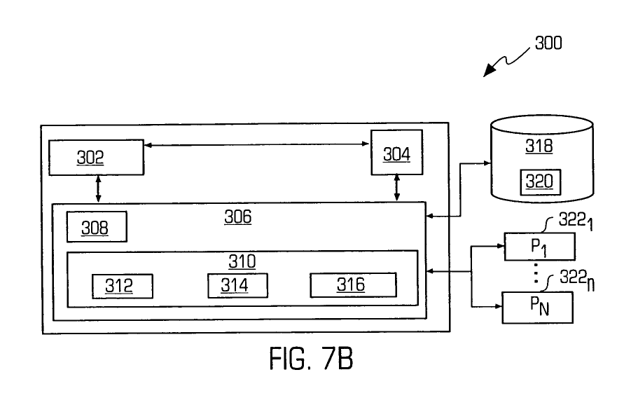

FIG. 7A is a diagram that illustrates a method 200 by which the intermediary in accordance with the invention processes a payment request. In step 202, the intermediary receives a notification of a payment request. When a Transaction Request is received, the intermediary identifies the source of the Transaction Request and the format in which the Transaction Request has been sent. It also identifies the processor to which the Transaction Request should be directed. In step 204, the intermediary may assign a session ID and transaction ID to the Transaction Request. In step 206, the intermediary determines if a processor service is initiated. If the processor service is not initiated, then an error is posted in step 208. If the processor service for the particular Payment Processor is initiated, then the intermediary determines if a Worker Thread is available in step 210. In particular, for the purpose of concurrently performing transactions, each Transaction Request is processed by a dedicated “Thread” wherein a Thread is the basic unit to which the operating system allocates processor time. This dedicated Thread which PayBridge allocates for processing requests is called a “Worker Thread”. The number of Worker Threads specifies the number of concurrent transactions that PayBridge should handle at any given point of time since one Worker Thread at any point of time can process only one Transaction Request. During this process, the Worker Thread consumes one Processor object corresponding to the Transaction Request. If a Worker Thread is available and the corresponding Processor Object is available then the Transaction Request is taken up for processing. If on the other hand, no Worker Threads are available or if the corresponding Processor object is not available then the Transaction Request goes into the queue as described below in step 212.

To better understand these concepts, consider the following example (with the following configurations settings). In this example, the system may have three (3) Worker Threads (Worker 1, Worker 2 and Worker 3.) Furthermore there may be two objects allocated for a Processor with code 1001, one object allocated for a Processor with code 1002 and three objects allocated for a Processor with code 1002.

In this case, the system would operate as follows:
I) Request for Processor 1001 ID: 1
   Request for Processor 1002 ID: 2
   Request for Processor 1003 ID: 3

Assuming all the Transaction Requests come at the same time, the Transaction Requests will be handled concurrently by PayBridge in the order below.
Worker 1—Request for Processor 1001 ID: 1

Worker 2—Request for Processor 1002 ID: 2
Worker 3—Request for Processor 1003 ID: 3
II) Request for Processor 1001 ID: 1
   Request for Processor 1002 ID: 2
   Request for Processor 1002 ID: 3
   Request for Processor 1001 IID: 4
   Request for Processor 1001 IID: 5
   Request for Processor 1001 IID: 6

Returning to FIG. 7A, if a Worker Thread is not available, then the Transaction Request is added to the queue in step 212 that waits until a Worker Thread is available. If the Worker Thread is available, then in step 214, the intermediary determines if a processor object is available and add the Transaction Request to the queue in step 212 if a processor object is not available. When a Transaction Request is in the queue, the intermediary determines if there are any Transaction Requests in the queue in step 216 and loops back to step 210 to process the queued Transaction Request. If there are no other Transaction Requests in the queue, then the method is completed.

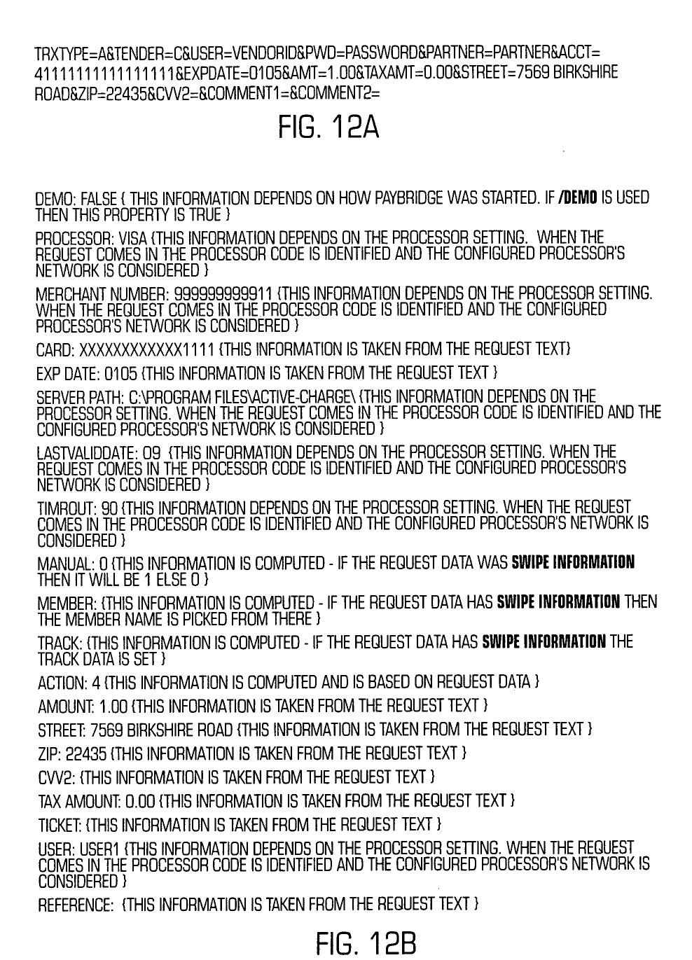

When a processor object and Thread is free, it begins to process the Transaction Request. It translates the Transaction Request from its current format to the format in which the processor requires Transaction Requests to be transmitted in step 218. In step 220, the intermediary attempts to validate the Transaction Request and posts an error in step 208 if the Transaction Request is not valid or transmits the Transaction Request in step 222 after validating it. On receiving the response in step 224 from the processor, the intermediary translates the Transaction Request back to the format recognized by the source of the Transaction Request in step 226. Thus, the intermediary in accordance with the invention accommodates different Payment Processors and different formats so that any Payment Processor may be used with a Business Software System wherein the seamless integration of the Payment Processor exists without the undue expense of integrating the new Payment Processor into the Business Software System. In accordance with a preferred embodiment of the invention, the system may include an XML-based translator that converts/translates between the different formats of the Payment Processors. FIGS. 12A and 12B described below provide an example of a Transaction Request and the corresponding translated output sent to PCCharge. An example of a computer systems implementation of the Credit Card Payment Processing System in accordance with the invention is described in more detail as follows.

FIG. 7B a block diagram illustrating an example of a computer-implemented Credit Card Payment Processing System 300 in accordance with the invention. The Credit Card Payment Processing System may also be implemented as one or more software modules/pieces with a plurality of instructions of code residing on a physical data storage medium, such as a CD, DVD or other storage medium, wherein the software is installed from the CD onto a computer system for execution or executed by the computer system directly from the physical data storage medium. Similarly, the Credit Card Payment Processing System may be implemented as pieces of software embedded onto a hardware device wherein a computer system executes the Credit Card Payment Processing System using the hardware device. The computer implemented system 300 comprises various well known computer resource components whose function and operation are not described as they are well known, including one or more processors 302, a persistent storage device 304, such as a hard disk drive, optical drive, tape drive or flash memory, and a memory 306, such as DRAM or SRAM that stores the data and instructions being executed by the computer while the computer is turned on. The computer system 300 may further include other well known components such as various input/output devices and devices that connect the computer system to the Internet and a computer network.

To implement the Credit Card Payment Processing System in accordance with the invention, the computer implemented system includes/is connected to a database 318 and one or more Payment Processors 322₁-322ₙ as shown. The computer-implemented system 300 further includes one or more pieces of software/modules that implement the Credit Card Payment Processing System such as a well known operating system 308 and a Credit Card Payment Processing System 310 in accordance with the invention. The Credit Card Payment Processing System may further include one more modules including a user interface module 312, a monitor module 314 and a payment processing module 316. In the example shown, these pieces of software reside in the memory 306 and are being executed by the processor 302 to implement the Credit Card Payment Processing System. For example, the user interface portion 312 may generate the user interfaces presented to the user during the execution of the Credit Card Payment Processing System, the monitor module 314 may monitor the credit card payment Transaction Requests as shown in more detail in FIG. 6 and the payment processing module handles payment requests as shown in FIG. 7A. Thus, each step shown in FIGS. 6 and 7A may be implemented using one or more computer program instructions. In accordance with the invention, the Credit Card Payment Processing System may utilize one or more Payment Processor profiles based on information 320 stored in the database 318 (which may be the same database used for the Business Software System shown in FIG. 1) and assist the Payment Processors 322₁-322ₙ in the completion of the credit card payment request. Examples of the user interfaces for the Credit Card Payment Processing System in accordance with the invention are described in more detail as follows. First, a user interface to configure the system in accordance with the invention will be described.

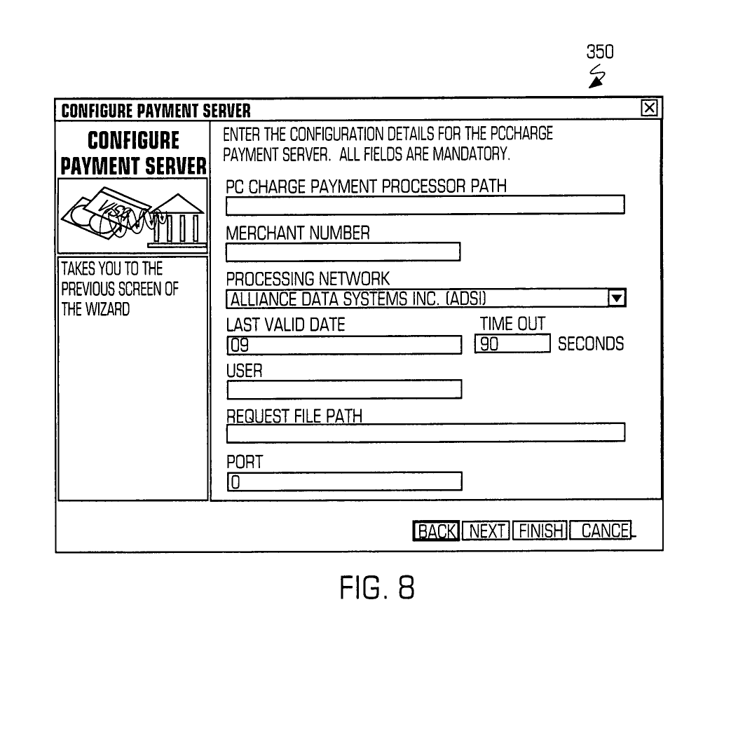

FIG. 8 illustrates an example of a user interface 350 for configuring an intermediate payment system in accordance with the invention. In this example, the intermediate payment system is being configured to operate with the PC Charge Payment Server for which the particular Business Software System is not configured. As shown, various variables, such as the server path, merchant name or processing network may be configured for each merchant and each Payment Processor.

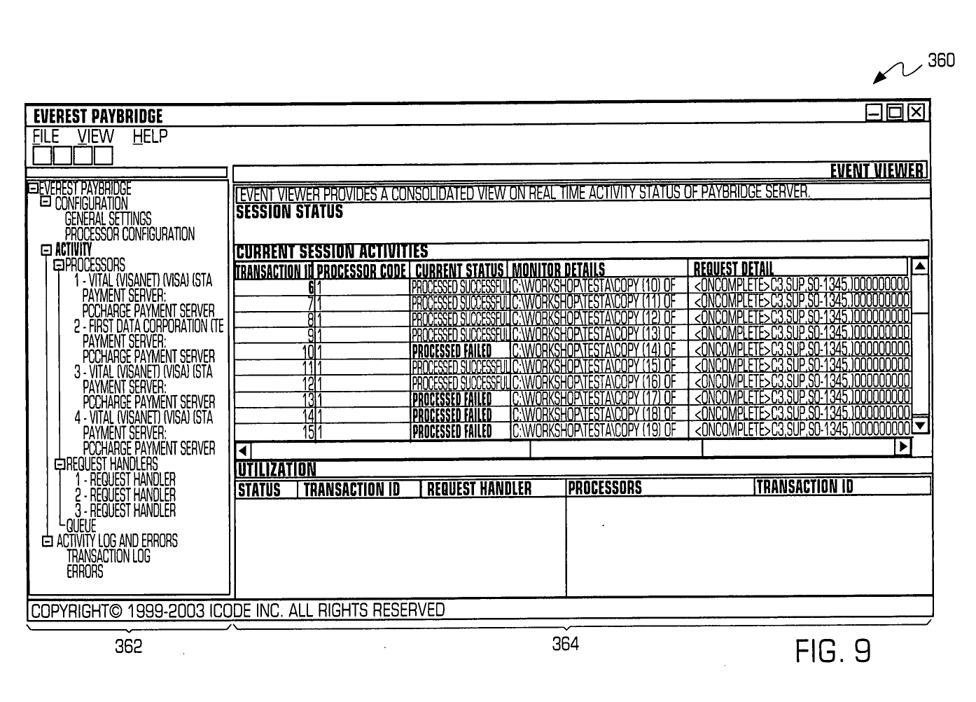

FIG. 9 illustrates an example of a user interface 360 for monitoring and displaying the status of the different Transaction Requests received by the Credit Card Payment Processing System. The user interface may include a summary portion 362 and an event monitor viewer 364. As shown in the summary portion, the credit card payment requests for one or more different Payment Processors is being monitored. In the event monitor viewer 364, each payment transaction is monitored and the current status of each transaction is viewable by the user.

In accordance with the invention, there is provided a method and an apparatus for a Business Software System to communicate with different Payment Processors without having to generate Transaction Requests in the specific formats stipulated by each processor or having the necessary mechanisms for directly communicating with the processor.

In accordance with one aspect of the invention, the Intermediary Payment Processor has the required definitions for communication protocols and Transaction Requests from Business Software Systems in the formats understood by ICVERIFY and PayFlowPro. It also has the corresponding formats for the data format supported by PC Charge Payment Server. The Intermediary Payment Processor thus monitors the specified ports or folders for Transaction Requests in a format published by ICVERIFY and PayFlowPro and translates these Transaction Requests to formats published by PC Charge Payment Server. It then translates the response from PC Charge Payment Server to the format published by ICVERIFY or PayFlowPro as the case may be. The Business Software System from which the Transaction Request originated will now be able to decipher the response and carry out further actions based on the type of response.

The credit card processing system provides many advantages. The system permits Business Software Systems to support multiple Payment Processors without making changes to their code base. The system also enables the existing users of Business Software Systems to switch to a Payment Processor not supported by their current Business Software System without having to make changes to the data setup in their software or having to resort to a manual system of processing. The system also permits the users of multiple Business Software Systems to use a single intermediary and multiple Payment Processors and multiple merchant accounts. The system also allows the websites and online shops that are dependent on TCP/IP and other protocols for real time payment processing to conveniently use Payment Processors that are based on an alternate method of connection such as dial up without having to make changes to their website or online shop.

Thus, in accordance with the invention, a Payment Processor is provided. The Payment Processor stores the required definitions for communication protocols and Transaction Requests from Business Software Systems in the formats understood by any payment processing software and the formats for the data format supported by the payment server so as to monitor the specified ports or folders for Transaction Requests in a format published by the payment processing software. The system has a means to translate these Transaction Requests to formats published by the payment server and a means for translating the response from the payment server to the format published by the payment processing software so as to enable the Business Software System from which the Transaction Request has originated to decipher the response and carry out further actions based on the type of response.

In accordance with another aspect of the invention, a Payment Processor is provided. The Payment Processor is software comprising a set of instructions to format the transaction data based on the payment processing software, set up the merchant account information for each merchant account with the corresponding payment server, identify the output mode of the transactions requests for this merchant account as a Transaction Request file or through a port, identify the folder in which the Transaction Request file is to be placed or the port to which the Transaction Request is to be sent, specify the maximum number of transactions that the intermediary is allowed to process concurrently and in each step, updates the database with the setup data. The Payment Processor may further include software instructions to intercede between the Business Software System and the Payment Processor by receiving Transaction Requests and assigning them for further processing by retrieving the information for particular monitor and processor from its database, begin monitoring based on the monitor type, create a repository of the processor templates objects based on the number of concurrent transactions specified, create Workers Threads based on the configuration settings and create the number of workers available, such that if workers are available end the process, or if workers are not available create Workers Threads and then end the process.

In accordance with yet another aspect of the invention, a Payment Processor is provided that is software comprising a set of instructions. The software formats the transaction data based on the payment processing software, sets up the merchant account information for each merchant account with the corresponding payment server, identifies the output mode of the Transaction Requests for this merchant account as a Transaction Request file or through a port, identifies the folder in which the Transaction Request file is to be placed or the port to which the Transaction Request is to be sent, and specifies the maximum number of transactions that the intermediary is allowed to process concurrently and in each step, updates the database with the setup data. The software also has a further set of software instructions to process a payment Transaction Request comprising a means to identify the source of the Transaction Request and the format in which the Transaction Request has been sent, identifying the processor to which the Transaction Request should be directed, assigning the Transaction Request received to the processor object and the Thread, and if free, begin to process the Transaction Request by translating the Transaction Request from its current format to the format in which the processor requires the Transaction Requests to be transmitted and then transmit the Transaction Request after due validation, redirecting the response from the processor to the format recognized by the source of the Transaction Request, or in case the processor object and the Thread are not free, send it to the queue.

In accordance with yet another aspect of the invention, a method for operating an Intermediary Payment Processor is provided. In the method, the definitions for transaction data generated by the Business Software System are specified along with the equivalent definitions to be used for transmitting such information to the Payment Processor. The definitions for the format into which the responses from the Payment Processor need to be converted are specified in order that the information can be read and understood by the Business Software System. Furthermore, the folders or ports that need to be monitored by the intermediary for Transaction Requests are specified from the Business Software System and the merchant account and other information is specified that would be used by the intermediary to connect to the Payment Processor. The method may preserve these definitions in the form of metadata. The method may start the monitoring service whereby the folders or ports would be monitored for Transaction Requests. The method also handles Transaction Requests and conveys the results of the Transaction Requests to the respective folders or ports.

FIG. 10 illustrates an example of a configuration user interface 400 in which the user can configure the monitoring functionality of the payment processing system. As shown, the user interface permits the user to specify various monitoring details including the file path, the processor code, the file extensions and the timeout periods for the monitoring process. Similarly, a processor configuration interface 410 is shown in FIG. 11 that permits the user of the system to specify various payment server details that permit the system to interact with the particular payment server.

FIGS. 12A and 12B illustrate an example of a payment processing request and the translated output for PCCharge, respectively. The example of the payment processing request is in the format required by PayFlowPro. In accordance with the invention, the system is capable of generating Transaction Requests for many different payment processors. The translated output (generated by the payment processing system in accordance with the invention) is for the PCCharge Payment Server. For PCCharge, it provides a COM object and the properties of this object is set after parsing the text sent from both ICVERIFY and PayFlowPro Transaction Request formats. Thus, an example of the properties of the COM object for the PayFlowPro Transaction Request shown in FIG. 12A is shown in FIG. 12B. FIG. 12B contains comments for each object property that are enclosed in the curly brackets.

While the foregoing has been with reference to a particular embodiment of the invention, changes in this embodiment may be made without departing from the principles and spirit of the invention, the scope of which is defined by the appended claims.

1. An intermediate payment processor for processing payments between a business software system and a payment processor, the system comprising:
a database containing one or more definitions wherein each definition is a definition for communication protocols including one of a specified port and folder, transaction requests from the business software system in the formats understood by each payment processor, and the formats for the data format supported by a payment server of the payment processor; and
a payment processing module further comprising a means for monitoring the specified ports or folders for a transaction request in a format published by the payment processor, means for translating the transaction request into a format published by the payment server based on the definition for the payment server in the database and a means for translating a response from the payment server into a format of the payment processing module so as to enable the business software system from which the request has originated to decipher the response and carry out further actions based on the type of response.

2. The system of claim 1, wherein the payment processing module further comprises means for setting up a merchant account information for each merchant account with the corresponding payment server, means for identifying an output mode of the transactions requests for each merchant account as a request file or through a port, means for identifying a folder in which the request file is to be placed or the port to which the request is to be sent, and a means for specifying the maximum number of transactions that the intermediary is allowed to process concurrently and in each step, updates the database with the setup data.

3. The system of claim 2, wherein the payment processing module further comprises means for intercepting a transaction request from the business software system and assigning the transaction request to a particular payment processor based on the definitions contained within the database, means for monitoring the transaction request based on the definition associated with that transaction request, means for generating a repository of the processor templates objects based on the number of concurrent transactions specified, and a means for creating workers threads based on the configuration settings and create the number of workers available.

4. An intermediate payment processor for processing payments between a business software system and a payment processor, the system comprising:
a database containing one or more definitions wherein each definition is a definition for communication protocols including one of a specified port and folder, transaction requests from the business software system in the formats understood by each payment processor, and the formats for the data format supported by a payment server of the payment processor; and
a payment processing module comprising a computer program wherein the computer program further comprises instructions that monitor the specified ports or folders for a transaction request in a format published by the payment processor, instructions that translate the transaction request into a format published by the payment server based on the definition for the payment server in the database and instructions that translate a response from the payment server into a format of the payment processing module so as to enable the business software system from which the request has originated to decipher the response and carry out further actions based on the type of response.

5. The system of claim 4, wherein the payment processing module further comprises instructions that set up a merchant account information for each merchant account with the corresponding payment server, instructions that identify an output mode of the transactions requests for each merchant account as a request file or through a port, instructions that identify a folder in which the request file is to be placed or the port to which the request is to be sent, and instructions that specify the maximum number of transactions that the intermediary is allowed to process concurrently and in each step, updates the database with the setup data.

6. The system of claim 5, wherein the payment processing module further comprises instructions that intercept a transaction request from the business software system and assigning the transaction request to a particular payment processor based on the definitions contained within the database, instructions that monitor the transaction request based on the definition associated with that transaction request, instructions that generate a repository of the processor templates objects based on the number of concurrent transactions specified, and instructions that create workers threads based on the configuration settings and create the number of workers available.

7. A payment processor comprising:
a piece of software wherein the software further comprises one or more sets of instructions;
wherein a first set of instructions further comprise instructions to format transaction data based on a type of payment processing software, instructions to set up a merchant account information for each merchant account with a corresponding payment server, instructions to identify an output mode of each transactions request for the merchant account as one of a request file and through a port, instructions to identify a folder in which the request file is to be placed or the port to which the request is to be sent, instructions to specify a maximum number of transactions that the intermediary is allowed to process concurrently and instructions to update a database; and
wherein a second set instructions further comprises instructions to process a payment request further comprising instructions to identify a source of the request and a format in which the request has been sent, instructions to identify a payment processor to which the request should be directed, instructions to assign the request to a processor object and a thread, instructions that process the request when a free processor object and thread are available by translating the request from a current format to a format in which the payment processor requires the requests to be transmitted and instructions to transmit the request after due validation, instructions to redirect the response from the processor to the format recognized by the source of the request, or in case the processor object and the thread are not free send it to the queue.

8. An intermediate payment processing method for processing payments between a business software system and a payment processor, the method comprising:
providing a database containing one or more definitions wherein each definition is a definition for communication protocols including one of a specified port and folder, transaction requests from the business software system in the formats understood by each payment processor, and the formats for the data format supported by a payment server of the payment processor;
monitoring the specified ports or folders for a transaction request in a format published by the payment processor;
translating the transaction request into a format published by the payment server based on the definition for the payment server in the database; and
translating a response from the payment server into a format of the payment processing module so as to enable the business software system from which the request has originated to decipher the response and carry out further actions based on the type of response.

9. The method of claim 8 further comprising setting up a merchant account information for each merchant account with the corresponding payment server, identifying an output mode of the transactions requests for each merchant account as a request file or through a port, identifying a folder in which the request file is to be placed or the port to which the request is to be sent, and specifying the maximum number of transactions that the intermediary is allowed to process concurrently and in each step, updates the database with the setup data.

10. The method of claim 9 further comprising intercepting a transaction request from the business software system, assigning the transaction request to a particular payment processor based on the definitions contained within the database, monitoring the transaction request based on the definition associated with that transaction request, generating a repository of the processor templates objects based on the number of concurrent transactions specified, and creating workers threads based on the configuration settings and create the number of workers available.
